(19) United States
(12) Patent Application Publication
(10) Pub. No.: US 2008/0037209 A1
(43) Pub. Date: Feb. 14, 2008

(54) Computer chassis for two motherboards oriented one above the other

(75) Inventors: Eren Niazi, San Jose, CA (US); Marc Rotzow, San Jose, CA (US); Bryan Rodriguez, Snohomish, WA (US)

Correspondence Address: FENWICK & WEST LLP, SILICON VALLEY CENTER, 801 CALIFORNIA STREET, MOUNTAIN VIEW, CA, 94041, US

(73) Assignee: Open Source Systems, Inc., Sunnyvale, CA (US)

(21) Appl. No.: 11/503,313

(22) Filed: Aug. 11, 2006

(51) Int. Cl. G06F 1/16

(52) U.S. Cl. 361/683

(57) ABSTRACT

One embodiment of the invention is a computer chassis for housing modules of a computer system. According to this embodiment, the chassis features a chassis base, a first tray for a motherboard removably engaged with the chassis base, and a second tray for a motherboard removably engaged with the chassis base. The second tray is oriented above the first tray when engaged in the chassis base. This embodiment also features a plurality of drawers for storage equipment, such as hard drives, where each drawer is removably engaged with the chassis base. The drawers are oriented laterally to the first and second trays in the chassis base.

### BACKGROUND OF THE INVENTION

1. Field of the Invention

This invention relates generally to a chassis for a computer system and in particular to a chassis that can accommodate multiple servers and that has a tight form factor.

2. Description of the Related Art

A number of problems face those who use servers as part of computer systems. One problem is a limitation in the size and orientation of the chassis for a server. Although the use of modular components has increased, the average server is only configurable in one arrangement, and is thus not versatile. Other servers can only accommodate a limited number of configurations due to the chassis design. Many density-oriented solutions allow few hard drives or require specialized components that increase the cost of the servers and thus the total cost of ownership. Removing these limitations would benefit consumers of enterprise solutions. Thus, there is a need for a server that meets needs for computing power balanced against the needs of a data center to control its cooling and electric power consumption, while keeping the cost of the servers down.

### SUMMARY OF THE INVENTION

In general, in one aspect, the invention features a computer chassis for housing modules of a computer system. According to this embodiment, the chassis features a chassis base, a first tray for a motherboard removably engaged with the chassis base, and a second tray for a motherboard removably engaged with the chassis base. The second tray is oriented above the first tray when engaged in the chassis base. This embodiment also features a plurality of drawers for storage equipment, such as hard drives, where each drawer is removably engaged with the chassis base. The drawers are oriented laterally to the first and second trays in the chassis base.

According to another aspect, the invention also features a computer chassis for housing modules of a computer system. In this embodiment, the computer chassis features a chassis base, a plurality of drawers for electronic modules, first and second trays for motherboards, and a plurality of backplanes removably engaged with the chassis base. The drawers can be removably engaged at the front of the chassis base. The first and second trays can be removably engaged with the chassis base at the rear of the chassis base, with the second tray being oriented above the first tray when engaged in the chassis base. The backplanes can be oriented between the front and the rear of the chassis base, with each backplane accompanying an electronic module on one of the drawers.

These embodiments of the invention allow two independent systems to be configured in a single chassis having a standard height of two units. This allows for improvement in reliability of server farms, simplifies cooling issues associated with increased server density, and increases the variety of configurations of the servers in the chassis. For example, each motherboard can select from a pool of electronic components in the drawers. For example, in some embodiments, the drawers can house hard drives. In addition, the chassis can accommodate three rows of four hard drives each. Thus, the motherboards can connect to any number of the hard drives as desired for a given configuration.

### BRIEF DESCRIPTION OF THE DRAWINGS

FIG. 1 is a front perspective view of a computer chassis in accordance with embodiments of the invention;

FIG. 2 is a perspective view of a tray for a motherboard in accordance with the embodiment of FIG. 1;

FIG. 3 is a perspective view of a drawer for an electric module in accordance with the embodiment of FIG. 1;

FIG. 4 is a top view of the drawer of FIG. 3;

FIG. 5 is a front view of the drawer of FIG. 3;

FIG. 6 is a side view of the drawer of FIG. 3;

FIG. 7 is a perspective view of a backplane in accordance with the embodiment of FIG. 1;

FIG. 8 is a top view of the backplane of FIG. 7;

FIG. 9 is a front view of the backplane of FIG. 7; and

FIG. 10 is a side view of the backplane of FIG. 7.

### DETAILED DESCRIPTION

One embodiment of the invention is a chassis designed to improve the overall availability of computers conforming to known standards for data centers. The chassis contains two servers, which can be entirely independent, and a number of drive bays (such as, in one embodiment, twelve drive bays) that are not specifically assigned to either of the two servers. The chassis of this embodiment allow two servers to be configured in a single chassis having a standard height of two units. Thus, the chassis takes up two units in height in a standard server rack. This highly versatile configuration can lower overall power consumption, allow for a large variety of configurations for the end consumer, and simplify serviceability. In some embodiments, the chassis is designed to be easily mounted in a standard server rack.

Server Racks

Servers are typically stored in racks or cabinets in a data center. A server rack can be a standard 19-inch rack (Electronic Industries Alliance 310-D, International Electrotechnical Commission 60297 and Deutsches Institut für Normung 41494 SC48D) system for mounting various electronic modules in a “stack”, or rack, 19 inches (482.6 mm) wide. Equipment designed to be placed in a rack is typically described as rack-mount, a rack mounted system, a rack mount chassis, sub-rack, or sometimes, simply a shelf.

The rack's mounting fixture usually includes two parallel metal strips (also referred to as “rails”) standing vertically. Typically, the strips are each 0.625 inches (15.875 mm) wide and are separated by a gap of 17.75 inches (450.85 mm), giving an overall rack width of 19 inches (482.6 mm). The strips have holes in them at regular intervals, with both strips matching, so that each hole is part of a horizontal pair with a center-to-center distance of 18.3 inches (464.82 mm).

The holes in the strips are arranged vertically in repeating sets of three, with center-to-center separations of 0.5 inch (12.7 mm), 0.625 inch (15.875 mm), and 0.625 inch (15.875 mm). The hole pattern thus repeats every 1.75 inches (44.45 mm). Racks are divided into regions, 1.75 inches in height, within which there are three complete hole pairs in a vertically symmetric pattern. The holes are centered 0.25 inch (6.35 mm), 0.875 inch (22.225 mm), and 1.5 inches (38.1 mm) from the top or bottom of the region. Such a region is commonly known as a “unit” or a “U,” and heights within racks are measured by such a unit. Rack-mountable equipment is designed to occupy some integral number of U. For example, rack-mountable computers are most often 1 U or 2 U in height. Thus, it is desirable to design chassis for computer systems that can engage with standard racks.

A typical cabinet usually conforms to these internal standards as well. Instead of a two-post structure, they usually have a four-post structure. In this case, servers are mounted on four-post rails that typically allow the machine to slide in and out of the cabinet. The typical depth is approximately 30 inches for servers with a small amount of additional space for airflow, door space, as well as for any cables, such as for a monitor, or serial or power cables. The cabinet can contain side panels that help to conceal and channel cabling as well as structure airflow. The cabinet can also have doors that may or may not contain a locking mechanism. These doors can have a glass front or perforated front. It is preferable to utilize a perforated cabinet, which allows for better airflow and cooling.

Cabinets are typically placed in rows within a data center and arranged in formations that facilitate cooling by designating one aisle for cooling facing the front of the machines and a second aisle for exhausting heat, i.e., a “hot aisle.” While a typical cabinet contains 42 Rack Units of space (in height) internally, it does not always allow for placement of 42 1 U servers because networking equipment or other equipment, such as a serial console aggregator box or monitor, may be mounted in the cabinet. Density of servers in the cabinet can be limited based on cooling and power arrangements within the data center.

Chassis

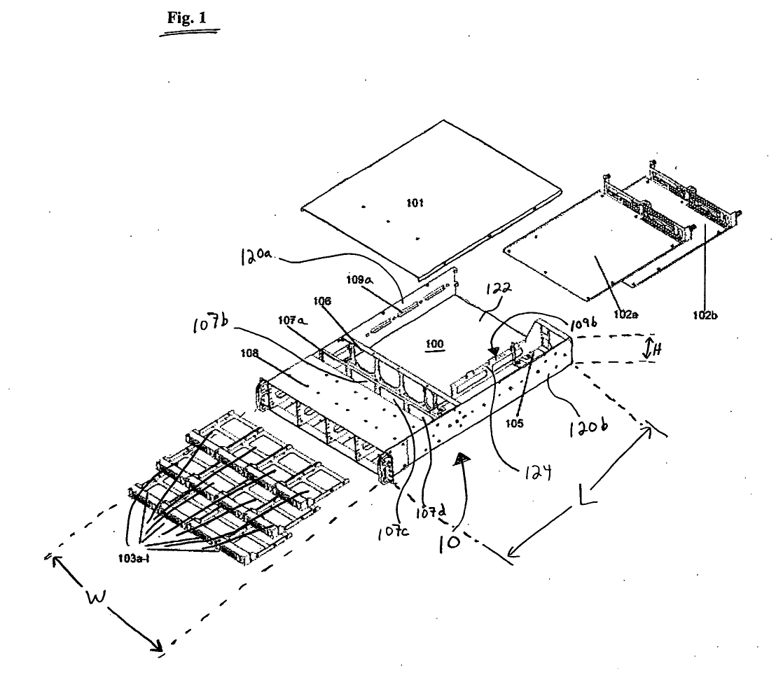

FIG. 1 is a front perspective view of a computer chassis 10 in accordance with embodiments of the invention. In this embodiment, the chassis 10 includes a chassis base 100, at least two trays 102a, 102b for motherboards (not shown) of the computer system, and a plurality of drawers 103a-103l for electronic modules, such as hard drives (not shown). The chassis 10 can include a plurality of backplanes 107a, 107b, 107c, 107d. The chassis 10 also includes a top or lid 101. When assembled, these components form a chassis 10 for a computer system that can, in some embodiments, be 2 units in height. The components of the chassis 10 can be made from a variety of materials, including, for example, metals and plastics.

The chassis base 10 includes a bottom wall 122 and two sidewalls 120a, 120b. In the embodiment of FIG. 1, the bottom wall 122 is rectangular in shape, as are the two sidewalls 120a, 120b. The two sidewalls 120a, 120b are assembled at approximately 90 degree angles to the bottom wall 122. Thus, in this embodiment, the chassis 10 is rectangular in shape when assembled.

When in use, the individual motherboards are placed on the system trays 102a, 102b. These trays 102a, 102b are designed to handle a number of server motherboards from a variety of manufacturers, such as, but not limited to Tyan, Supermicro, Asus, and Intel. The trays 102a, 102b can handle single or dual socket motherboards and up to one PCI card each. The trays 102a, 102b are fastened to the chassis 10 with screws or thumbscrews. More particularly, the trays 102a, 102b slide in on shelves or rails that are part of chassis 10. This separates the two motherboards within the chassis. For example, one set of rails 109a can be formed on sidewall 120a. Another set of rails 109b is formed on a railing system 124 situated within the chassis. FIG. 1 shows only one rail 109a on sidewall 120a. During use, the trays 102a, 102b slide within the chassis body such that the top 101 encloses the trays 102a, 102b within the chassis 10, with only one end of the trays 102a, 102b protruding from the rear of the chassis 10 for connections for ports of the computer system. In addition, the trays 102a, 102b are removably engaged within the chassis body 100 such that, when in use, tray 102a with one motherboard is situated vertically above tray 102b with another motherboard.

Electronic modules or components are housed in the drawers 103. The embodiment of FIG. 1 shows twelve such drawers 103a-103l organized as three rows of four drawers each. The drawers 103 are removably attachable to the chassis base 100. In one embodiment, hard drives for the motherboards are housed in the trays 103. In the embodiment of FIG. 1, there are twelve trays 103 with hard drives that are shared amongst the two servers in the chassis 10. These twelve hard drives can be configured between the two motherboards in any desired configuration. All twelve hard drives could be connected to the motherboard on tray 102a, the hard drives could be split so that six are attached to each motherboard, or any other allocation of hard drives to the motherboards can be used. The motherboards can connect via drive cables to any number of the hard drives.

The electronic modules on the drawers 103 are connected to backplanes 107. For example, if the electronic modules are hard drives, the drives connect to the backplanes 107. One embodiment of the invention uses three rows of backplanes 107, with four backplanes 107 per row. For example, FIG. 1 shows four backplanes 107a, 107b, 107c, 107d organized in a single row.

The drawers 103 are attached via thumbscrews to the chassis base 10. In addition, in an embodiment in which the drawers 103 are for hard drives, the drawers 103 can be fitted to connect to any type of drive, such as, but not limited to SATA, IDE, SCSI, SAS, or Fiber Channel. The drives are housed in the chamber 108 of the chassis base 10. The chamber 108 has shelves to separate the swappable drives so that they may easily slide in and out of the chassis 10.

Further features of the chassis 10 include fan housing pieces and a housing area 105 for power supplies. The chassis base 10 can include a number of fan housing frames situated within the chassis 10 for housing fans. The embodiment of FIG. 1 shows a fan housing piece 106 with housing space for a plurality of fans. In this embodiment, fans (not shown) mounted on fan housing piece 106 are capable of cooling both motherboards mounted on trays 102a, 102b. Each fan can cool two individual motherboards, thus resulting in an energy savings over systems where each fan cools only a single motherboard.

In the embodiment of FIG. 1, the overall dimensions of the chassis 10 are 24 inches in length L by 18.5 inches in width W. A chassis with these dimensions is designed to fit in a common server rack as set forth above. In addition, the height H of the chassis is approximately 2 U. Thus, the height H of the chassis is such that it will take up 2 U of space on a server rack.

FIG. 2 is a perspective view of one of the trays 102a, 102b for a motherboard in accordance with the embodiment of FIG. 1. FIG. 2 shows a perspective view from the rear of the server tray 102, whereas FIG. 1 shows a view from the front of the chassis 10 and also the front of the trays 102a, 102b. In one embodiment, the tray 102 includes a base 202 connected to a backplane structure 204. The backplane structure 204 is connected to the base 202 at approximately a 90-degree angle. The base 202 supports the weight of a motherboard when in use and can contain mounting holes (not shown) for connection of the motherboard to the base 202. The backplane structure 204 has a height of approximately 2 U and includes a plurality of openings 208 sized for various types of interconnection ports for the motherboards. During use, after attachment of a motherboard to the tray 102, the tray 102 can slide within the chassis base 100 of FIG. 1 so that the rails 210 of the tray 102 mate with the shelves 109a, 109b of the chassis base 100. After placement within the chassis base 100, the tray 102 can be fixed to the chassis base 100 using screws 206. The embodiment of FIG. 2 includes two such screws 206, each of which fits through a hole in the backplane structure 204 of the tray 102 and into a hole in either the side wall 120a or the structure having railing system 124.

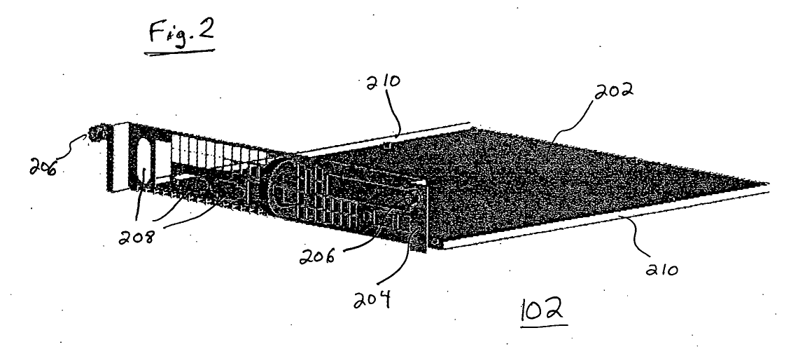

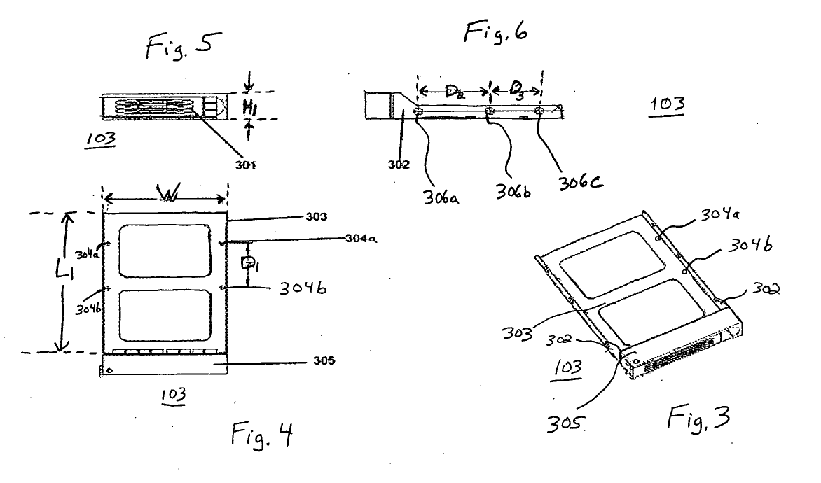

FIGS. 3 through 6 are isolated views of one of the drawers 103 for electronic modules shown in FIG. 1. In particular, FIG. 3 is a front perspective view of such a drawer 103, FIG. 4 is a top view, FIG. 5 is a front view, and FIG. 6 is a side view. As set forth above, each drawer 103 can be a drive tray for a hard drive. In such an embodiment, the drive tray 103 can have a width W₁ of about 4.06 inches and a length L₁ of about 6.43 inches. The drive tray 103 can include a base metal case 303 and an enclosed housing structure 305 that includes a door 301 for the drive bay. The case 303 is a generally flat, rectangular-shaped metal structure that can be used to affix a drive or other electronic module to the drawer 103. The housing structure 305 is affixed to one end of the case 303. In one embodiment, shoulders 302 on each side of the metal case 303 can be used to affix the housing structure 305 to the case 303. The housing structure 305 can include a lever (not shown) to pull out the hard drive 305 from the chassis 10.

The drive tray 103 contains a number of holes that can be used to screw a hard drive (not shown) into the metal case 303. For example, the tray 103 can contain two sets of holes 304a, 304b (seen best in FIG. 4) that can be used to affix screws in a vertical orientation into the case 303 to attach a hard drive. In the embodiment of FIGS. 3 through 6, these holes 304a, 304b are spaced apart by a length D₁ of about 1.35 inches, thus accommodating a standard hard drive. In addition, the metal case 303 can have holes oriented in order to affix screws in a lateral direction into the case 303 to attach a hard drive. For example, FIG. 6 shows three sets of holes 306a, 306b, 306c in the side of the metal case 303. In one embodiment, holes 306a and 306b are spaced apart by a length D₂ of about 2.36 inches. In addition, holes 306b and 306c are spaced apart by a length D₃ of about 1.62 inches. With these dimensions, the holes 304, 306 can be used to affix standard 3.5 inch hard drives. That is, this hole-spacing pattern conforms to the standard for a 3.5 inch hard drive and is an international standard set by committee for manufacturers of hard drives. In one embodiment, the drive trays 103 are about 1.03 inches in height H₁ and accommodate the standard low profile to 1 inch thickness of a standard 3.5 inch wide hard drive.

The front view of FIG. 5 shows the an opening plate 301 to the drive tray 103. Such an opening plate 301 could contain, for example, a company logo or the like. The opening plate 301 can be perforated as depicted in FIG. 5 to allow for increased air flow over the drives.

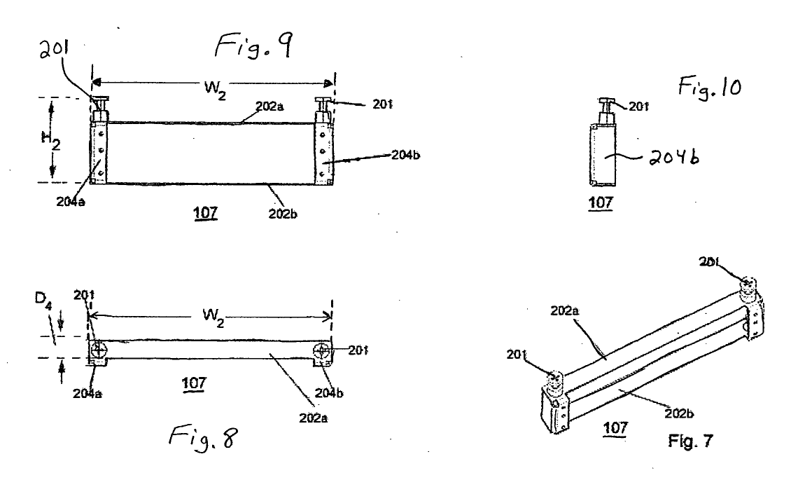

FIGS. 7-10 are isolated views of one of the backplanes 107 of FIG. 1. In particular, FIG. 7 is a perspective view of such a backplane 107, FIG. 8 is a top view, FIG. 9 is a front view, and FIG. 10 is a side view. Such a backplane can be used to connect one of the electronic modules in the drawers 103 to one of the motherboards on the trays 102. For example, the backplane 107 can be a piece used to connect a hot swappable hard drive on a drawer 103 to one of the servers on a tray 102. The backplane 107 can be fitted with any standard single component for connecting hard drives or other electronic components. In addition, power and cabling can be connected as known to a person of ordinary skill.

The backplane 107 includes a top shell 202a and a bottom shell 202b. The top shell 202a forms the top of the backplane 107 and the bottom shell 202b forms the bottom of the backplane 107. Each of the top and bottom shells 202a, 202b are, in this embodiment, substantially rectangular in shape and are essentially thin metal plates with a relatively thin thickness in height. In other embodiments, the sizing of these shells 202a, 202b can vary. The two shells 202a, 202b are connected through two collar regions 204a, 204b, with one collar region on either side of the backplane 107. Thus, collar region 204b connects the ends of shells 202a, 202b on the right side, and collar region 204a connects shells 202a, 202b on the left side. The shells 202a, 202b can be affixed to the collar regions 204a, 204b through any method, including through the use of screws or bolts. In another embodiment, the backplane 107 can be made from one piece of metal that is cut and then curved in order to form the shape of FIGS. 7-10. Each of the collar regions 204a, 204b includes a hole for engagement with a thumbscrew, thus allowing for removable attachment of the backplane 107 to the chassis 10. For example, in the embodiment of FIGS. 7 through 10, two thumbscrews 201 can be used for attachment of each backplane to the chassis base 100. These thumbscrews 201 can also be used for attachment of the backplanes 107 to each other.

The dimensions of the backplanes 107 can be sized in accordance with the electronic components to be used. In the illustrated embodiments, the backplanes 107 are sized in accordance with the drawers 103 for hard drives. In one embodiment, each backplane 107 measures about 4.06 inches in width W₂, approximately 0.43 inches in depth D₄ at its thickest point, and about 1 inch in height H₂ when screwed down via the thumbscrews 201.

The chassis 10 described herein has a number of advantages over prior art configurations, including power consumption, serviceability, and versatility. This server configuration can lower power consumption by virtue of its design. Because the embodiments described herein are each a 2 U chassis, there is only a single row of fans required to cool each of the two motherboards enclosed therein. This can lead to a significant amount of power savings. Additionally, because of its design, passive heat syncs can be used to cool the motherboards in the chassis 10. A passive heat sync is a block of copper or other conductive material on the top of the motherboard. An active heat sync, on the other hand, would be a block of copper or conductive material combined with a fan. An active heat sync draws power, but a passive heat sync does not. In some embodiments, fans may not be needed to cool the motherboards and electronic modules within the chassis 10.

In the described embodiments, each of two motherboards is mounted to a swappable tray 102 that fits on a shelf in the chassis base 100. By simply disconnecting power and drive cables, a system board can be easily removed and replaced. This can significantly limit down time and make servicing the motherboards easier. A new motherboard can be swapped into the server in a matter of minutes. Normally, the removal and remounting of the motherboard from the chassis would take several minutes and introduce the risk of over tightening the motherboard to the chassis. Using the chassis design of the present invention, a processor or memory element could be swapped out in a very simple fashion. This simplified method for swapping the motherboard and its components can limit downtime to a minimum.

The chassis design of the present invention also allows for a large variety of configurations. There are two motherboards in a 2 U form factor, essentially forming two servers. These two servers can be made from standard components. Each motherboard tray 102 can contain a standard motherboard, and no specialized parts (aside from the chassis design itself) are employed to make the two systems in the chassis 10 work. This lowers costs, because the motherboards and other components can be purchased from a variety of manufacturers. In contrast, a custom component increases cost because, typically, customized manufacture is required. As long as one has the chassis 10, the other standard components can be purchased on a timely basis, when needed.

High availability is another concern for many customers. With two servers in a single chassis 10, one can configure through the use of software and hardware to avoid system failures. For example, one of the motherboards in the chassis 10 can be configured to take over when the other motherboard fails. One could also configure the servers to work as a cluster. The customer could run active-active failover whereby both servers simultaneously run, and in the case of failure of one server, the second server takes over the function of the first server for a period of time. This redundancy can easily be built into a system using the 2 U chassis of the present invention.

Due to the nature of the design having two motherboards in a single chassis 10, the motherboards can be configured in a very large variety of ways. One server can be a web or application server utilizing one or two of the hard drives in the drawers 103 (in an embodiment having twelve drawers 103), while the second server could be a database server or storage server utilizing the remaining ten or eleven hard drives in the drawers 103. The drives could be split between the two servers, as designed by the customer.

The backplanes 107 in the chassis 10 connect to the twelve possible hard drives or electronic modules (in the embodiment of FIG. 1) and are adjustable to support multiple interfaces as well as a large variety of motherboards, whether they are SCSI, SATA, PATA, or SAS motherboards. The backplanes 107 are not permanently affixed, but instead are individual units. This allows for better air flow and utilization of standard components. It also allows for a mixture of different types of electronic modules. For instance, one server can use two SCSI drives, while the second server could use two SATA drives. In addition, some motherboards may be capable of using multiple types of drives, and the chassis 10 of the invention allows for a mix and match of hard drives on an individual motherboard. In addition, a computer system can be easily upgraded by replacing backplanes 107 and drawers 103 with configurations for different electronic components.

The hot swappable drive bays in some embodiments of the chassis 10 are ventilated to allow for an influx of air flow. Additionally, the drawers 103 are components that may be interchanged based on the type of hard drive used, as certain hard drives and backplanes have different methods for communicating drive power and usage activity.

The overall size of the chassis 10 at slightly more than 24 inches in length can also provide for advantages. As it is shorter in depth by approximately six inches compared to a standard 30″ server, the chassis 10 of some embodiments of the invention leaves additional room for cooling and a larger variety of racks that the server can be installed into. This also leaves room for employment of different cooling methods down the backside and the possible inclusion of an active exhaust system.

The embodiment of FIG. 1 can be modified to include four servers in a single chassis 10 having a height of 2 U. In this embodiment, the server length L can be extended by 6 inches to a total length of about 30 inches. The chamber 108, which houses drawers 103 in FIG. 1, can be combined with the additional 6 inches of length to allow for two additional trays for motherboards, similar in design and layout to trays 102a, 102b, to be included in the front of the chassis 10. Like trays 102a, 102b, these trays in the front can be situated one above the other. These two trays can be oriented so that they may be removed from the front of the chassis 10, while trays 102a, 102b can still be removed from the rear of the chassis 10. In this embodiment, the drives for the servers on these additional trays, as well as for the servers on trays 102a, 102b, can be moved to the side portion of the chassis 10 parallel to sidewall 120b, such as close to housing area 105 in FIG. 1. Although twelve such drives may not fit within the chassis 10, as many as six drives may still fit within the chassis along the sidewall 120b. Such a layout would allow four servers to be included in a single chassis having a height of 2 U and having length and width dimensions to fit a standard server rack.

The dimensions described above are exemplary, and these dimensions can vary within the scope of the invention. In addition, the advantages of the present invention set forth above are exemplary only, and not all of these advantages need to be present to be within the scope of the invention. In addition, there may be numerous advantages provided by the chassis 10 of the present invention that are not set forth above. While the present invention has been described with reference to several embodiments thereof, those skilled in the art will recognize various changes that may be made without departing from the spirit and scope of the claimed invention. Accordingly, the invention is not limited to what is shown in the drawings and described in the specification, but only as indicated in the appended claims. Thus, other embodiments are within the scope of the following claims.

What is claimed is:

1. A computer chassis comprising:
a chassis base;
a first tray for a motherboard removably engaged with the chassis base;
a second tray for a motherboard removably engaged with the chassis base, the second tray being oriented above the first tray when engaged in the chassis base;
a plurality of drawers for storage equipment, each drawer removably engaged with the chassis base, the plurality of drawers being oriented laterally to the first and second trays in the chassis base.

2. The chassis of claim 1, wherein the chassis has a height of two standard units.

3. The chassis of claim 1, wherein the storage equipment are hard drives.

4. The chassis of claim 1, wherein the plurality of drawers for storage equipment include three rows of four drawers.

5. The chassis of claim 1, wherein each motherboard includes I/O connectors including keyboard, video, mouse, USB and network ports.

6. The chassis of claim 5, wherein the keyboard, video, and mouse ports are accessible from the rear of the chassis when the motherboards are in place in the trays.

7. The chassis of claim 6, wherein the plurality of drawers for storage equipment are accessible from the front of the chassis.

8. The chassis of claim 6, wherein network connections from the motherboards are connected in the rear of the chassis.

9. The chassis of claim 1, wherein the first and second trays are engaged with the chassis base via thumbscrews.

10. The chassis of claim 1, further comprising a plurality of backplanes removably engaged with the chassis base, wherein each backplane accompanies a storage device.

11. The chassis of claim 1, further comprising at least one fan connected to the chassis base, the fan for cooling the motherboards.

12. The chassis of claim 11, wherein heat is exhausted out of the rear of the chassis.

13. The chassis of claim 1, wherein the chassis is connected to a rack via a system of rails, wherein the chassis has a height of two standard units of the rack.

14. A computer chassis comprising:
a chassis base;
a plurality of drawers for electronic modules, the drawers removably engaged at the front of the chassis base;
first and second trays for motherboards, the first and second trays removably engaged with the chassis base at the rear of the chassis base, the second tray being oriented above the first tray when engaged in the chassis base; and
a plurality of backplanes removably engaged with the chassis base between the front and the rear of the chassis base, wherein each backplane accompanies an electronic module on one of the drawers.

15. The computer chassis of claim 14, wherein each backplane is engaged with the chassis base via thumbscrews.

16. The computer chassis of claim 14, wherein the first and second trays are engaged with the chassis base via thumbscrews.

17. The computer chassis of claim 14, wherein the plurality of drawers for storage equipment include three rows of four drawers.

18. The computer chassis of claim 14, wherein the electronic modules are hard drives.

19. The computer chassis of claim 14, wherein the chassis is connected to a rack via a system of rails, wherein the chassis has a height of two standard units of the rack.

20. The computer chassis of claim 14, further comprising at least one fan coupled to the chassis base adjacent the backplanes.
